(19) United States
(12) Patent Application Publication
(10) Pub. No.: US 2023/0418531 A1
(43) Pub. Date: Dec. 28, 2023

(54) NON-TRANSITORY RECORDING MEDIUM STORING COMPUTER-READABLE PROGRAM, INFORMATION PROCESSING DEVICE, AND PRINT SETTING GENERATION METHOD

(71) Applicant: Konica Minolta, Inc., Tokyo (JP)

(72) Inventor: Atulkumar GAUTAM, Tokyo (JP)

(73) Assignee: Konica Minolta, Inc., Tokyo (JP)

(21) Appl. No.: 18/335,185

(22) Filed: Jun. 15, 2023

(30) Foreign Application Priority Data
Jun. 22, 2022 (JP) 2022-100486

(51) Int. Cl. G06F 3/12; H04N 23/60

(52) U.S. Cl. CPC G06F 3/1254; H04N 23/64; G06F 3/1204

(57) ABSTRACT

At least one image of a print sample captured by a camera configured separately from an image forming device is acquired. At least one appearance feature of the print sample is specified from the at least one image. A value of an item corresponding to each of the at least one appearance feature of the print sample is acquired by referring to information associating the value of each of the at least one item constituting the print setting with each of the at least one appearance feature. The print setting is generated using the value of the item corresponding to the at least one appearance feature.

The entire disclosure of Japanese Patent Application No. 2022-100486, filed on Jun. 22, 2022, is incorporated herein by reference in its entirety.

### BACKGROUND

### Technological Field

The present disclosure relates to generation of a print setting.

### Description of the Related Art

When a printed matter is reprinted, a printing company generates a new print setting for the printed matter. In such a case, an operator in the printing company is required to newly generate the print setting based on a print sample. Because a complex combination of setting items is required for bookbinding, a lot of labor is required. Accordingly, there has been a need for a technique for reducing the labor of generating the print setting.

With regard to such a problem, a technique of generating a setting for printing from an image of the print sample in an image forming device such as a multi-functional peripheral (M P) has been proposed (for example, Japanese Laid-Open Patent Publication No. 2014-220560).

### SUMMARY

However, in the technique described in Japanese Laid-Open Patent Publication No. 2014-220560, the print sample is required to be disposed at a reading position of a scanner of the image forming device. The print sample is unevenly separated or creased in order to be disposed in such the position. Accordingly, the conventional technique has a problem that the print sample is damaged.

The present disclosure has been made in view of such circumstances, and an object of the present disclosure is to provide a technique of easily generating the print setting of the print sample without damaging the print sample.

According to one aspect of the present disclosure, a non-transitory recording medium that stores a computer-readable program, wherein the program causes a computer to generate print setting of an image forming device, and the program is executed by at least one processor of the computer to cause the at least one processor to execute: acquiring at least one image of a print sample captured by a camera configured separately from the image forming device; specifying at least one appearance feature of the print sample from the at least one image; acquiring a value of an item corresponding to each of the at least one appearance feature by referring to information associating at least one item's value constituting the print setting with the at least one appearance feature respectively; and generating the print setting using the value of the item corresponding to the at least one appearance feature.

According to another aspect of the present disclosure, an information processing device includes: a memory that stores the program; and at least one processor that executes the program stored in the memory.

According to still another aspect of the present disclosure, a method for generating print setting of an image forming device, the method includes: acquiring at least one image of a print sample captured by a camera configured separately from the image forming device; specifying at least one appearance feature of the print sample from the at least one image; acquiring a value of an item corresponding to each of the at least one appearance feature by referring to information associating at least one item's value constituting the print setting with the at least one appearance feature respectively; and generating the print setting using the value of the item corresponding to the at least one appearance feature.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a view illustrating an overall configuration of a printing system.

FIG. 2 is a view illustrating hardware configurations of a smartphone 2, a client PC 3, and tan image forming device 4.

FIG. 3 is a view illustrating functional configurations of the smartphone 2 and the client PC 3.

FIG. 4 is a view schematically illustrating a processing flow in a printing system 1.

FIG. 5 is a view schematically illustrating a scene where the smartphone 2 captures a print sample with a camera 26.

FIG. 6 is a view illustrating an example of a content of a setting table.

FIGS. 7 and 8 are views illustrating an example of a method for specifying a feature regarding an aspect ratio of an object in a captured image.

FIGS. 9 to 11 are views illustrating an example of a method for specifying a number of binding members in the captured image.

FIGS. 12 and 13 are views illustrating an example of a method for specifying a side shape of a lowermost area.

FIGS. 14 to 17 are views illustrating a first example of a method for specifying a position of a turned sheet.

FIGS. 18 and 19 are views illustrating a second example of the method for specifying the position of the turned sheet.

FIGS. 20 and 21 are views illustrating a third example of the method for specifying the position of the turned sheet.

FIGS. 22 and 23 are views illustrating a fourth example of the method for specifying the position of the turned sheet.

FIGS. 24 to 28 are views illustrating an example of a method for specifying a number of binding position vertices.

FIG. 29 is a view illustrating an example of a setting screen regarding a printer driver 320.

FIG. 30 is a view illustrating another example of the setting screen regarding the printer driver 320.

FIG. 31 is a flowchart illustrating processing performed as generation of a print setting in S14 and transmission of a print setting in S16 in FIG. 4.

FIG. 32 is a view illustrating an example of a display screen of a first wizard.

FIG. 33 is a view illustrating an example of the display screen of a second wizard.

FIG. 34 is a view illustrating an example of a print setting display screen.

FIG. 35 is a view illustrating an example of a screen selecting a transmission destination of the print setting in the smartphone 2.

FIG. 36 is a view illustrating an example of a screen notifying completion of the transmission of the print setting in the smartphone 2.

FIG. 37 is a flowchart illustrating processing of a modification in FIG. 31 when the smartphone 2 also functions as a printer driver.

FIG. 38 is a view illustrating another example of the print setting display screen.

### DETAILED DESCRIPTION OF EMBODIMENTS

Hereinafter, one or more embodiments of the present invention will be described with reference to the drawings. However, the scope of the invention is not limited to the disclosed embodiments.

With reference to the drawings, an embodiment of a printing system will be described below. In the following description, the same components and constituents are denoted by the same reference numerals. Names and functions of such components are also the same. Accordingly, these descriptions will not be repeated.

[1. Configuration of Printing System]

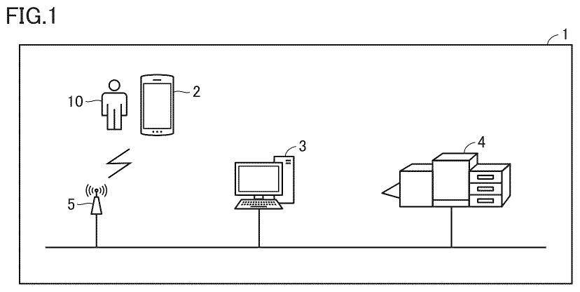

FIG. 1 is a view illustrating an overall configuration of a printing system. Printing system 1 includes a smartphone 2, a client personal computer 3 (hereinafter, also referred to as a “client PC 3”), an image forming device 4, and an access point 5. Client PC 3, image forming device 4, and access point 5 are configured to be communicable through a network. Smartphone 2 is configured to be communicable with client PC 3 and image forming device 4 by being connected to the network through access point 5. Smartphone 2 is operated by a user 10. Each of smartphone 2 and client PC 3 is an example of an information processing device.

In printing system 1, user 10 captures an image of a print sample using smartphone 2. Smartphone 2 generates a print setting corresponding to the print sample using at least one captured image of the print sample, and transmits the print setting to client PC 3. A printer driver is installed in client PC 3. In client PC 3, the printer driver produces a print instruction using the print setting transmitted from smartphone 2, and transmits the print instruction to image forming device 4. Image forming device 4 performs an image forming operation according to the print instruction transmitted from client PC 3.

[2. Hardware Configuration]

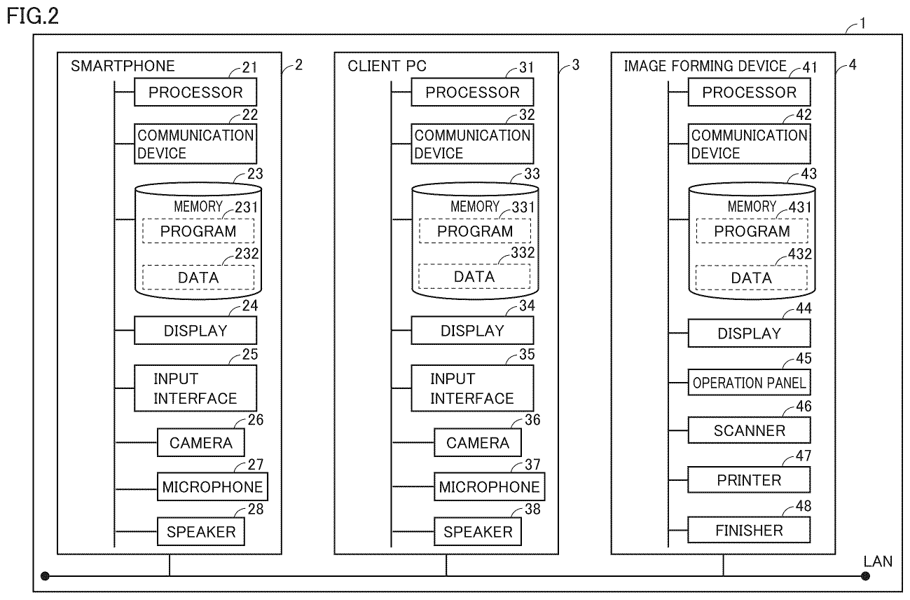

FIG. 2 is a view illustrating hardware configurations of smartphone 2, client PC 3, and image forming device 4. With reference to FIG. 2, each hardware configuration will be described below.

(Smartphone 2)

Smartphone 2 includes a processor 21, a communication device 22, a memory 23, a display 24, an input interface 25, a camera 26, a microphone 27, and a speaker 28, which are connected to each other by an internal bus.

Processor 21 is a computing entity that executes various pieces of processing by executing various programs. For example, processor 21 includes at least one of a central processing unit (CPU), a field programmable gate array (FPGA), and a graphics processing unit (GPU). Processor 21 may be configured of processing circuitry.

Communication device 22 establishes communication with each of external devices (for example, client PC 3 and image forming device 4) through a network, and transmits and receives data to and from each of the external devices.

Memory 23 is configured of a volatile memory and a nonvolatile memory. A program 231 and data 232 are non-temporarily stored in memory 23. Program 231 is used to control smartphone 2 and is executed by processor 21. Data 232 is used to control smartphone 2.

Display 24 displays various calculation results in smartphone 2. For example, input interface 25 is a touch sensor and/or an operation button, and receives input from user 10. Camera 26 captures an image. Microphone 27 receives voice input. Speaker 28 outputs sound. Processor 21 may control smartphone 2 according to an input operation to input interface 25 and/or according to the voice input to microphone 27.

(Client PC 3)

Client PC 3 includes a processor 31, a communication device 32, a memory 33, a display 34, an input interface 35, a camera 36, a microphone 37, and a speaker 38, which are connected to each other by the internal bus.

Processor 31 is a computing entity that executes various pieces of processing by executing various programs. For example, processor 31 is configured of at least one of a CPU, an FPGA, and a GPU. Processor 31 may be configured of processing circuitry.

Communication device 32 establishes communication with each of external devices (for example, smartphone 2 and image forming device 4) through the network, and transmits and receives data to and from each of the external devices.

Memory 33 is configured of a volatile memory and a nonvolatile memory. A program 331 and data 332 are non-temporarily stored in memory 33. Program 331 is used to control client PC 3 and is executed by processor 31. Data 332 is used to control client PC 3.

Display 34 displays various calculation results in client PC 3. For example, input interface 35 is a touch sensor, a keyboard, and/or a mouse, and receives the input from user 10. Camera 36 captures the image. Microphone 37 receives the voice input. Speaker 38 outputs the sound.

(Image Forming Device 4)

Image forming device 4 includes a processor 41, a communication device 42, a memory 43, a display 44, an operation panel 45, a scanner 46, a printer 47, and a finisher 48, which are connected to each other by the internal bus. In one implementation example, image forming device 4 is implemented by combining finisher 48 with the MFP including processor 41, communication device 42, memory 43, display 44, operation panel 45, scanner 46, and printer 47.

Processor 41 is a computing entity that executes various pieces of processing by executing various programs. For example, processor 41 includes at least one of a CPU, an FPGA, and a GPU. Processor 41 may be configured by processing circuitry.

Communication device 42 establishes communication with each of external devices (for example, smartphone 2 and client PC 3) through the network, and transmits and receives data to and from each of the external devices.

Memory 43 includes a volatile memory and a nonvolatile memory. A program 431 and data 432 are non-temporarily stored in memory 43. Program 431 is used to control image forming device 4 and is executed by processor 41. Data 432 is used to control image forming device 4.

Display 44 displays various calculation results in image forming device 4. For example, operation panel 45 is a touch sensor and/or an operation button, and receives the input from user 10.

Scanner 46 scans a set manuscript and generates image data of the manuscript. Because a known method can be adopted as a method for generating the image data in scanner 46, detailed description will not be repeated here. Printer 47 prints the image data (for example, the image data read by scanner 46 and the image data transmitted from the external device) on a medium (for example, printing sheet) by, for example, an electrophotographic method. Because a known technique can be adopted as a mode of image formation such as the electrophotographic method, detailed description will not be repeated here.

Finisher 48 implements a function performing finish processing on the medium. For example, the implemented function is a sorting function and a stapling function. The sorting function is a function ejecting the medium to a different tray or to a different position for each set when a plurality of sets of one manuscript are printed. The stapling function is a function stapling the medium for each set when the plurality of sets of copies are printed for one manuscript.

[3. Functional Configuration]

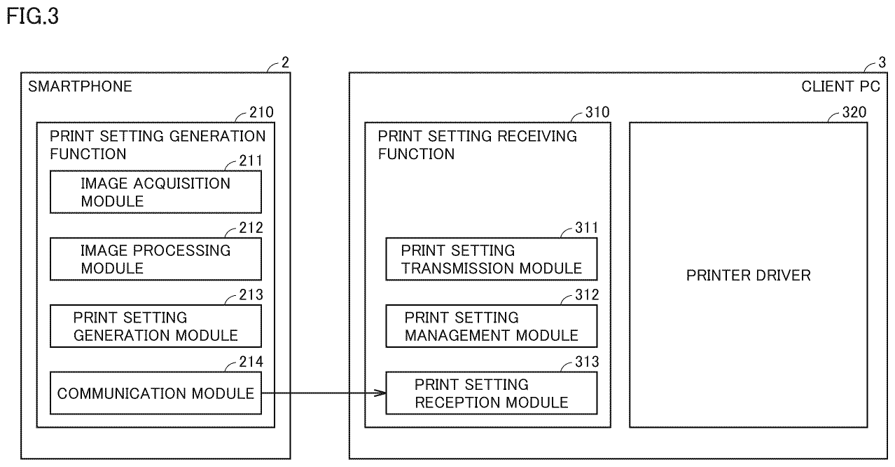

FIG. 3 is a view illustrating functional configurations of smartphone 2 and client PC 3.

(Smartphone 2)

Smartphone 2 has a print setting generation function 210. In one implementation, print setting generation function 210 is implemented by processor 21 executing a print setting generation application program (hereinafter, also referred to as a “print setting generation application”).

Print setting generation function 210 includes an image acquisition module 211, an image processing module 212, a print setting generation module 213, and a communication module 214.

Image acquisition module 211 controls camera 26 to acquire the captured image from camera 26.

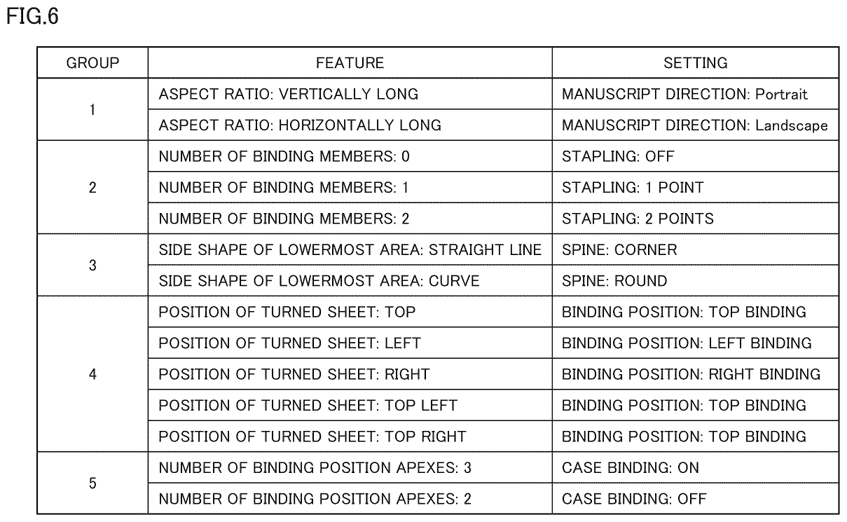

Image processing module 212 processes the captured image acquired from camera 26. The processing of the captured image includes the acquisition of a feature from the captured image. With reference to FIG. 6, a specific example of the feature acquired from the captured image will be described later.

Print setting generation module 213 generates the print setting using the feature acquired by image processing module 212.

Communication module 214 controls communication device 22 to transmit the print setting to client PC 3.

(Client PC 3)

Client PC 3 has a print setting receiving function 310 and a printer driver 320. Printer driver 320 is a function controlling image forming device 4. In one implementation example, each of print setting receiving function 310 and printer driver 320 is implemented by processor 31 executing a dedicated application program for each of print setting receiving function 310 and printer driver 320. Print setting receiving function 310 and printer driver 320 may be implemented by executing a single application program (for example, a printer driver program).

Print setting receiving function 310 includes a print setting reception module 313, a print setting management module 312, and a print setting transmission module 311.

Print setting reception module 313 communicates with print setting generation function 210 of smartphone 2 to receive the print setting from smartphone 2.

Print setting management module 312 manages (for example, storing the print setting in memory 33) the print setting transmitted from smartphone 2.

Print setting transmission module 311 passes the print setting to printer driver 320.

Printer driver 320 transmits the print instruction to image forming device 4. The print instruction may include the print setting transmitted from smartphone 2.

[4. Schematic Flow of Processing]

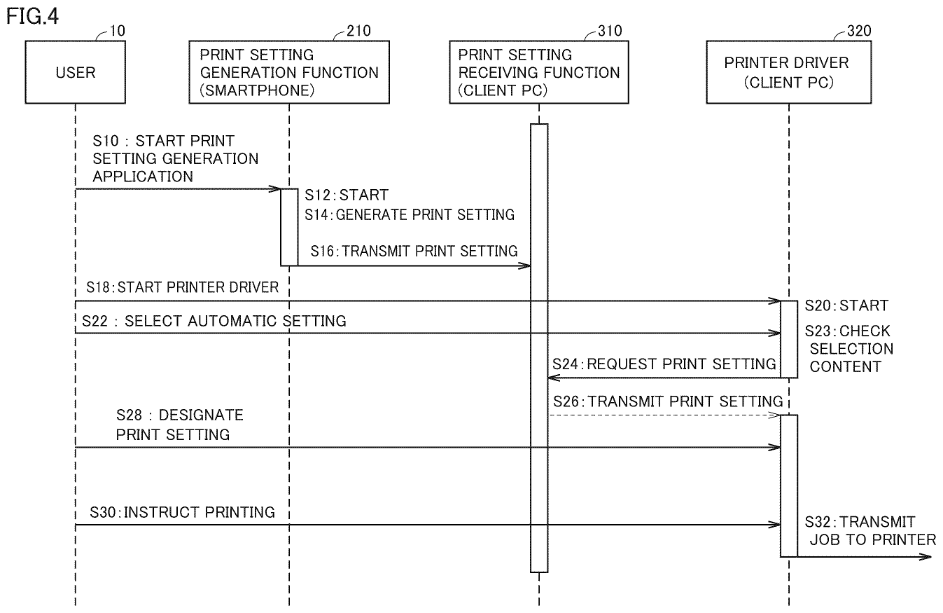

FIG. 4 is a diagram schematically illustrating a processing flow in printing system 1.

With reference to FIG. 4, in step S10, user 10 operates smartphone 2 to start the print setting generation application.

In response to this, smartphone 2 activates print setting generation function 210 in step S12.

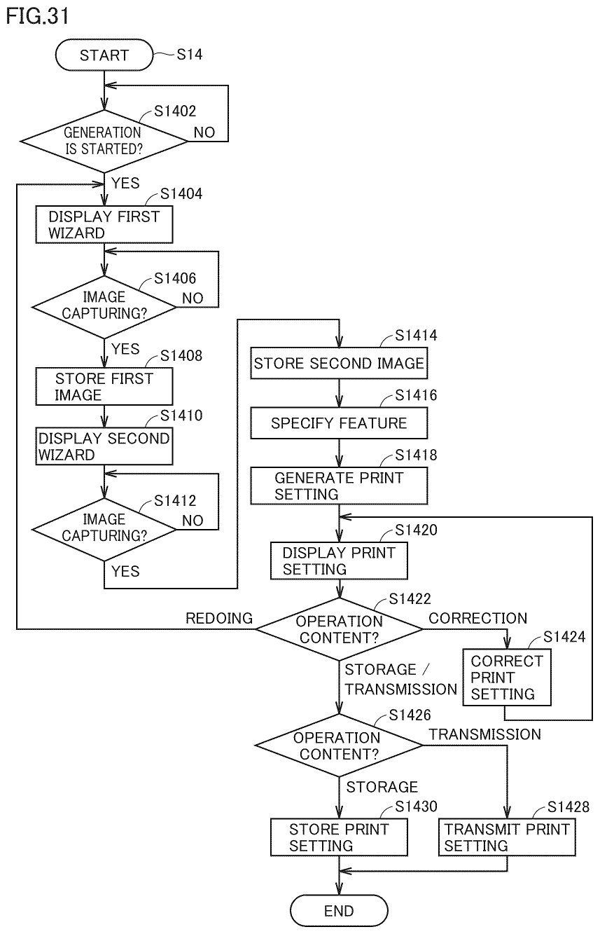

In step S14, smartphone 2 serving as print setting generation function 210 executes processing generating the print setting. With reference to FIG. 31 and the like, the content of this processing will be described later.

In step S16, smartphone 2 serving as print setting generation function 210 transmits the print setting to client PC 3. In client PC 3, print setting receiving function 310 receives the print setting.

In step S18, user 10 operates client PC 3 to activate the printer driver.

In response to this, client PC 3 activates printer driver 320 in step S20.

Printer driver 320 requests an instruction on which one of “automatic setting” and “manual setting” is selected as a type of setting regarding the generation of a job transmitted to image forming device 4. The automatic setting means that the print setting generated using the captured image as described with reference to FIG. 31 is used for generating the job. The manual setting means that the print setting generated using the captured image as described with reference to FIG. 31 is not used for generating the job.

In step S22, user 10 inputs the selection of the type of setting regarding the job generation to client PC 3 as printer driver 320. In the example of FIG. 4, user 10 selects the automatic setting.

In step S23, printer driver 320 checks the content of the selection (the automatic setting or the manual setting) input from user 10. The control of step S23 by printer driver 320 corresponds to receiving selection of whether to use the print settings generated in step S14 as print setting output to image forming device 4.

When the automatic setting is selected, printer driver 320 requests the print setting from print setting receiving function 310 in step S24.

In response to this, print setting receiving function 310 transmits the print setting to printer driver 320 in step S26.

In step S28, user 10 operates printer driver 320 to designate the print setting used for generating the job. Printer driver 320 presents the print setting transmitted from print setting receiving function 310, and in step S28, user designates the print setting as the print settings used for generating the job. When a plurality of print settings are transmitted from print setting receiving function 310, printer driver 320 may present the plurality of print settings to user 10. In step S28, user 10 may designate the print setting used for generating the job from the plurality of print settings.

In step S30, user 10 performs an operation instructing printer driver 320 to perform the printing.

In response to this, in step S32, printer driver 320 generates a print job using the specified print setting, and transmits the print job to the printer (image forming device 4).

[5. Items Constituting Print Setting and Appearance Feature]

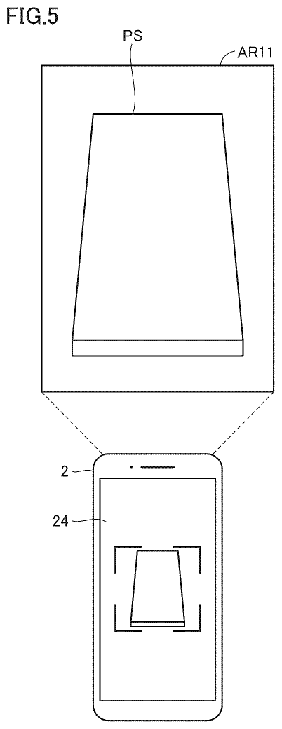

FIG. 5 is a view schematically illustrating a scene where smartphone 2 captures a print sample with camera 26. In FIG. 5, an area AR11 represents an area captured by camera 26. A print sample PS represents a print sample of which the image is captured.

In smartphone 2, print setting generation function 210 uses the captured image of the print sample to generate the print setting generating the printed matter corresponding to the print sample. In one implementation, print setting generation function 210 specifies the appearance feature of the print sample from the captured image, and generates the print setting using a setting corresponding to the specified feature.

FIG. 6 is a view illustrating an example of a content of a setting table. The setting table is an example of information that associates at least one item's value constituting the print setting with the at least one appearance feature respectively, and for example, is stored in memory 23 of smartphone 2. Such information may be in any format, and is not required to be in a table format in FIG. 6.

In the example of FIG. 6, the setting table associates the feature and the setting for five groups. Each group will be described below.

(Group 1: Aspect ratio of object)

In a group 1, the feature of the aspect ratio of the object and the setting are associated with each other. More specifically, the feature of “vertically long” for the aspect ratio of the object in the captured image is associated with a value “portrait” of the setting for an item “manuscript orientation”.

In the setting table of FIG. 6, the feature “horizontally long” for the aspect ratio of the object in the captured image is associated with a value “landscape” of the setting for the item “manuscript orientation”. The item “manuscript orientation” means the print setting representing the direction of the medium used for the image formation by printer 47 of image forming device 4.

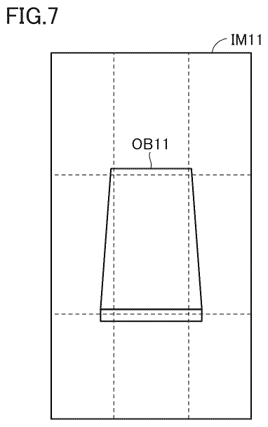

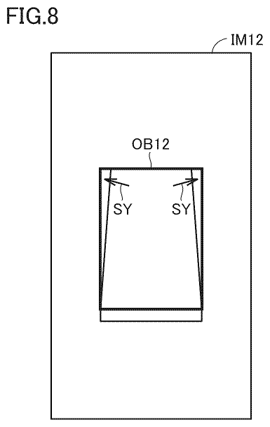

In one implementation, whether the aspect ratio of the object in the captured image is “vertically long” or “horizontally long” is specified based on the captured image. FIGS. 7 and 8 are views illustrating an example of a method for specifying the feature regarding the aspect ratio of the object in the captured image.

FIG. 7 illustrates an example of the captured image of the print sample as a captured image IM11. In captured image IM11, a broken line is an auxiliary line defining an area in captured image IM11. In captured image IM11, the print sample is taken as an object OB11.

In printing system 1, area extraction processing is executed on captured image IM11, and perspective transformation processing is executed on the extracted area. Thus, captured image IM11 in FIG. 7 is converted into a captured image IM12 in FIG. 8, and object OB11 in FIG. 7 is converted into an object OB12 in FIG. 8. Object OB12 may have a rectangular shape or a shape close to a rectangular shape. Object OB12 is expanded toward an outside of object OB11 as indicated by two arrows SY. Arrow SY illustrates supplementarily explaining the expansion of object OB11.

Then, in printing system 1, a dimension in a first direction (for example, in a vertical direction in the vertically long captured image) of the extracted area (object OB12) is compared with a dimension in a second direction (for example, in a horizontal direction in the vertically long captured image) intersecting the first direction, and the feature is specified based on a comparison result. In one implementation, the feature “vertically long” is specified when the dimension in the first direction is longer, and the feature “horizontally long” is specified when the dimension in the second direction is longer.

When a plurality of areas (a plurality of objects) are extracted in the captured image, the area including the center in the captured image may be specified from the plurality of areas, and the feature regarding the aspect ratio may be specified using the specified area.

The feature specification method described with reference to FIGS. 7 and 8 is merely an example, and any other known method can be adopted as the method for specifying whether the aspect ratio of the object in the captured image is “vertically long” or “horizontally long”.

For example, object OB11 corresponding to the print sample may be extracted from the captured image by pattern recognition processing using information (for example, a pattern image) registered previously for the print sample in addition to or instead of the area extraction processing.

(Group 2: Number of Binding Members)

In a group 2, the number of binding members in the object and the setting are associated with each other. More specifically, the feature that the number of binding members is “0” is associated with a setting value “OFF” for an item “stapling”.

In the setting table of FIG. 6, the feature that the number of binding members is “1” is associated with the setting value “1 point” for the item “stapling”. The feature that the number of binding members is “2” is associated with the setting value “2 points” for the item “stapling”. The item “stapling” represents the print setting regarding details of staple finishing by finisher 48 of image forming device 4. When the setting value is “OFF”, the staple finishing is not performed. When the setting value is “1”, the staple finishing is performed on one place of the medium on which the image is formed. When the setting value is “2”, the staple finishing is performed on two places of the medium on which the image is formed.

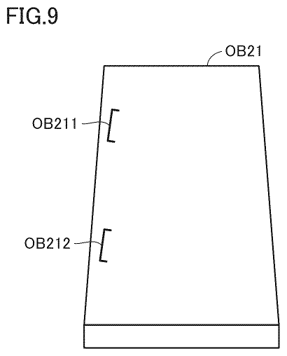

In one implementation, the number of binding members in the captured image is specified based on the captured image. FIGS. 9 to 11 are views illustrating an example of a method for specifying the number of binding members in the captured image.

An object OB21 in FIG. 9 represents an example of the object corresponding to the print sample extracted from the captured image. Object OB21 may be extracted by the area extraction processing executed on the captured image. Object OB21 includes two objects OB211, OB212 corresponding to binding members (binding needles), in printing system 1, for example, objects OB211, OB212 in an object OB1121 are extracted by a pattern recognition technique.

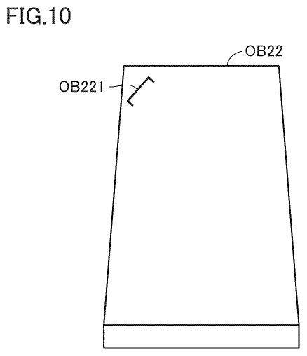

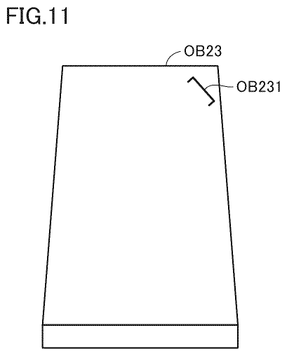

An object OB22 in FIG. 10 represents another example of the object corresponding to the print sample extracted from the captured image. An object OB23 in FIG. 11 represents still another example of the object corresponding to the print sample extracted from the captured image. Each of objects OB22, OB23 includes each of objects OB221, OB231 corresponding to the binding member.

In printing system 1, in the captured image, the number of objects corresponding to the binding copy in the object corresponding to the print sample is specified as the feature “0”, “1”, or “2” for the binding copy.

(Group 3: Side Shape of Lowermost Area)

In a group 3, the side shape feature of the lowermost area is associated with the setting. The “lowermost area” means a closed area located at the most end in the first direction (for example, in the longitudinal direction in the vertically long captured image) of a first orientation of the plurality of closed areas included in the object corresponding to the print sample. The “side shape” is specified based on the shape in the first orientation and the shape in a second orientation of the second direction (for example, in the horizontal direction in the vertically long captured image) intersecting the first direction. When both the first orientation and the second orientation are straight lines, “direct” is specified as the feature value. When at least one of the first orientation and the second orientation is not the straight line, “curved contact” is specified as the feature value.

In the setting table of FIG. 6, a feature value “straight line” is associated with a setting value “corner” for a spine. A feature value “curve” is associated with the setting value “corner” for the spine. The “spine” indicates the print setting regarding how the spine is attached to the sheet on which the image is formed by finisher 48 (alternatively, a device that performs another binding operation). In the present specification, the post-processing attaching the spine is also referred to as “case binding”.

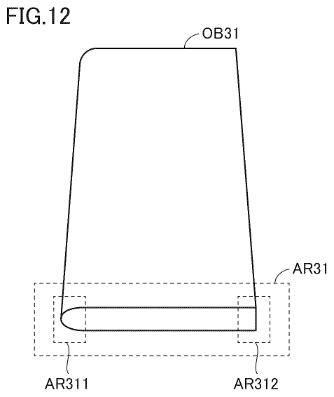

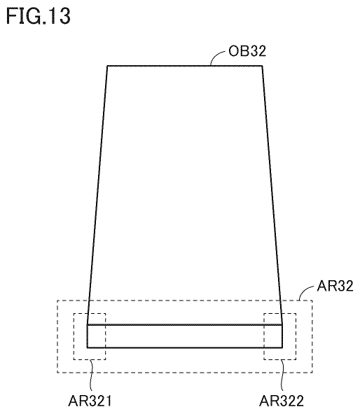

FIGS. 12 and 13 are views illustrating an example of a method for specifying the side shape of the lowermost area.

An object OB31 in FIG. 12 may be extracted by the area extraction processing executed on the captured image. In FIG. 12, the lowermost area of object OB31 is included in an area AR31. The feature of the side shape in the lowermost area of object OB31 is specified based on the shape of the left end of the lowermost area included in an area AR311 and the shape of the right end of the lowermost area included in an area AR312.

In the example of FIG. 12, the shape of the left end of the lowermost area included in area AR311 is the curve, not the straight line. The shape of the right end of the lowermost area included in area AR312 is the straight line. That is, in the example of FIG. 12, at least one of the first orientation and the second orientation of the lowermost area is not the straight line. Accordingly, in the example of FIG. 12, the “curve” is specified as the feature value of the side shape of the lowermost area.

An object OB32 in FIG. 13 may be extracted by the area extraction processing executed on the captured image. In FIG. 13, the lowermost area of object OB32 is included in an area AR32. The feature of the side shape in the lowermost area of object OB32 is specified based on the shape of the left end of the lowermost area included in an area AR321 and the shape of the right end of the lowermost area included in an area AR322.

In the example of FIG. 13, the shape of the left end of the lowest area included in area AR321 and the shape of the right end of the lowest area included in area AR322 are both the straight lines. Accordingly, in the example of FIG. 13, the “straight line” is specified as the feature value of the side shape of the lowermost area.

(Group 4: Position of Turned Sheet)

In a group 4, the feature of the position of the turned sheet and the setting are associated with each other. The “position of turned sheet” means the position of the turned sheet in the print sample relative to the body of the print sample. Five types (top, left, right, top left, and top right) are exemplified as the feature value of the “position of turned sheet”.

In the setting table of FIG. 6, the feature value of the “position of turned sheet” is associated with the value of the item “binding position” in the print setting. The “binding position” represents the print setting regarding the position at which the medium is bound when the post-processing binding the medium on which the image is formed is performed.

There are three types of post-processing binding the media referred to herein (“stapling”, “case binding”, and “saddle binding”). In “stapling”, at least two media are bound with the binding member. In “case binding”, at least two media are bound by wrapping the media with the spine. In “saddle stitching”, at least two media are folded together, and the binding member is fitted from the center portion of the medium located on the outermost side toward the medium located on the inside among the at least two media, thereby binding the at least two media.

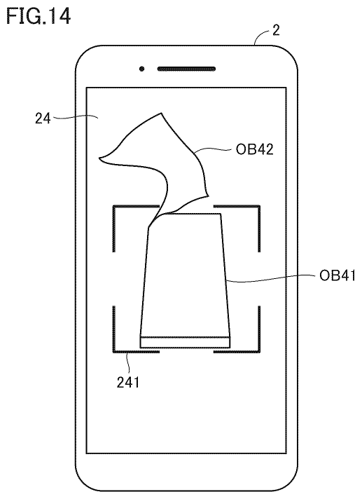

FIGS. 14 to 17 are views illustrating a first example of a method for specifying the position of the turned sheet.

FIG. 14 illustrates the state in which the captured image of camera 26 is displayed on display 24 of smartphone 2. An object OB41 corresponds to the main body of the print sample. An object OB42 corresponds to the turned sheet in the print sample. A frame 241 is displayed to assist user 10. User 10 adjusts the imaging area of camera 26 with respect to the print sample such that the main body of the print sample fits within frame 241.

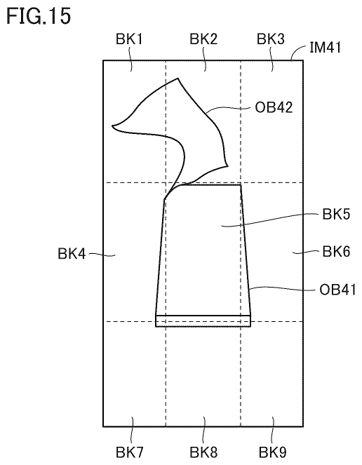

FIG. 15 illustrates a captured image IM41 captured in the state of FIG. 14. A broken line in captured image IM41 is an auxiliary line. These auxiliary lines define nine blocks BK1 to BK9 in captured image IM41. Blocks BK1 to BK9 are arrayed in a matrix of three rows and three columns. Block BK5 is located at the center of the nine blocks.

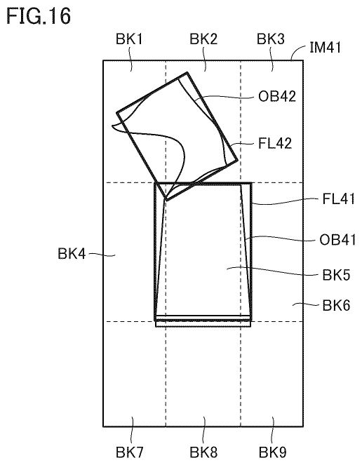

In FIG. 16, the positional relationship between objects OB41, OB42 extracted by the area extraction processing for captured image IM41 is schematically illustrated as frames FL41, FL42.

The value of the “position of turned paper” specifies whether each of at least one object in the captured image is the object corresponding to the main body of the print sample or the object corresponding to the turned sheet. In one example, the object at or above a given percentage located in block BK1 is specified as the object corresponding to the body of the print sample, and other object are specified as the objects corresponding to the turned sheet of the print sample.

Then, when the block covered by the object specified as corresponding to the turned sheet of the print sample includes block BK1, the value “upper left” is specified.

When the block covered by the object specified as corresponding to the turned sheet of the print sample includes block BK3, the value “top right” is specified.

When the block covered by the object specified as corresponding to the turned sheet of the print sample does not include blocks BK1, BK3, but includes block BK2, the value “up” is specified.

When the block covered by the object specified as corresponding to the turned sheet of the print sample includes block BK4, the value “left” is specified.

When the block covered by the object specified as corresponding to the turned sheet of the print sample includes block BK6, the value “right” is specified.

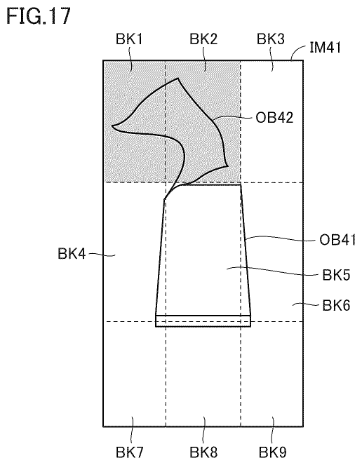

In the example of FIG. 15, object OB42 is specified as corresponding to the turned sheet of the print sample. In FIG. 17, blocks BK1, BK2 covered by object OB42 are hatched. In the example of FIG. 17, the block covered by object OB42 includes block BK1. Accordingly, in the example of FIG. 15, “upper left” is specified as the value of the feature “position of turned sheet”.

The method of specifying the value of the above-described feature “position of turned sheet” is merely an example. For example, the number of boxes defined in captured image IM41 is not limited to 9. Furthermore, the above-described “given ratio” can be appropriately set for each situation in which printing system 1 is implemented. At least, in captured image IM41, when the object corresponding to the main body of the print sample and the object corresponding to the turned sheet of the print sample are specified, and when the positional relationship of the latter object with respect to the former object is specified, the “position of turned sheet” can be specified by any other method.

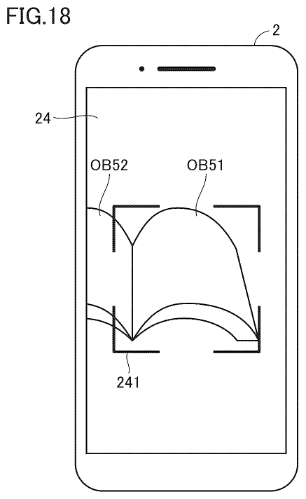

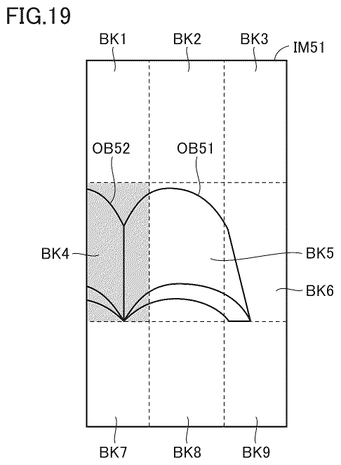

FIGS. 18 and 19 are views illustrating a second example of the method for specifying the position of the turned sheet.

FIG. 18 illustrates the state in which the captured image of camera 26 is displayed on display 24 of smartphone 2. An object OB51 corresponds to the main body of the print sample. An object OB52 corresponds to the turned sheet in the print sample. FIG. 19 illustrates a captured image IM51 corresponding to captured image IM41 in FIG. 17. In FIG. 19, the block covered by object OB52 is block BK4.

Accordingly, in FIGS. 18 and 19, “left” is specified as the value of the feature “position of turned sheet”.

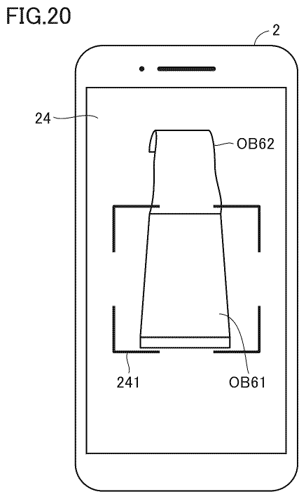

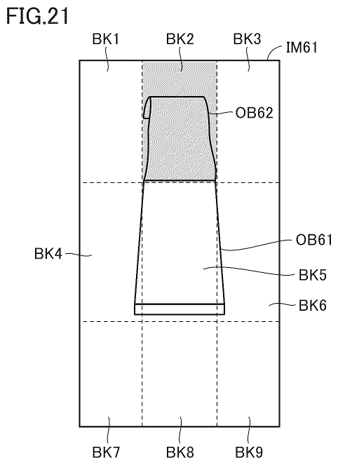

FIGS. 20 and 21 are views illustrating a third example of the method for specifying the position of the turned sheet.

FIG. 20 illustrates the state in which the captured image of camera 26 is displayed on display 24 of smartphone 2. An object OB61 corresponds to the main body of the print sample. An object OB62 corresponds to the turned paper in the print sample. FIG. 21 illustrates a captured image IM61 corresponding to captured image IM41 in FIG. 17. In FIG. 21, the block covered by object OB62 is block BK2.

Accordingly, in the examples of FIGS. 20 and 21, “up” is specified as the value of the feature “position of turned sheet”.

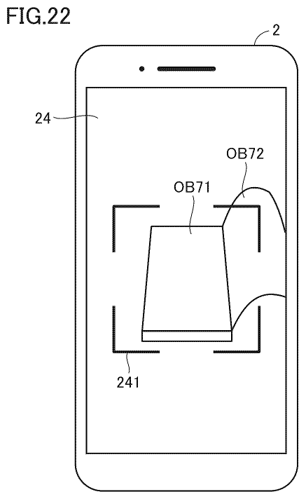

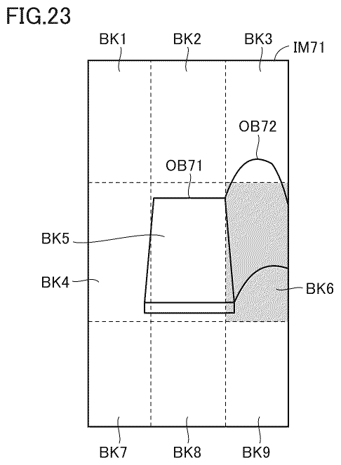

FIGS. 22 and 23 are views illustrating a fourth example of the method for specifying the position of the turned sheet.

FIG. 22 illustrates the state in which the captured image of camera 26 is displayed on display 24 of smartphone 2. An object OB71 corresponds to the main body of the print sample. An object OB72 corresponds to the turned sheet in the print sample. FIG. 23 illustrates a captured image IM71 corresponding to captured image IM41 in FIG. 17. In FIG. 23, the block covered by object OB72 is block BK6.

Accordingly, in the examples of FIGS. 22 and 23, “right” is specified as the value of the feature “position of turned sheet”.

(Group 5: Number of Binding Position Apexes)

In a group 5, the feature of the number of binding position vertices and the setting are associated with each other. The “number of binding position vertexes” means the number of vertexes specified in the area corresponding to the binding position of the print sample in the captured image.

In the setting table of FIG. 6, the feature value “3” is associated with the setting value “ON” for the case binding. The feature value “2” is associated with the setting value “OFF” for the case binding. In one implementation, in the print setting, the value of the setting for the case binding specifies the method for binding the medium on which the image is formed. When the value is “ON”, “case binding” is designated as the binding method. When the value is “OFF”, “saddle binding” is designated when the value of “number of binding members” is “0”, and “stapling” is designated when the value of “number of binding members” is “1” or “2”.

In one implementation, the number of binding position vertices is specified by extracting at least one vertex of the object in the captured image, selecting the vertex located in the area corresponding to the binding position from among the extracted at least one vertex, and specifying the number of selected vertices.

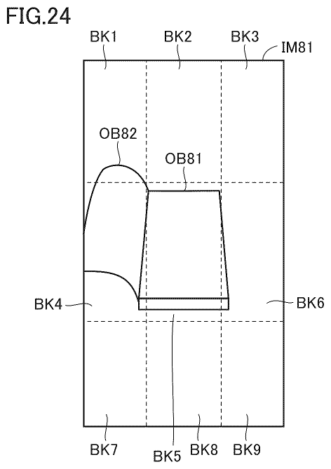

FIGS. 24 to 28 are diagrams for describing an example of a method of specifying the number of binding position vertices.

FIG. 24 illustrates an example of the captured image of the print sample as a captured image IM81.

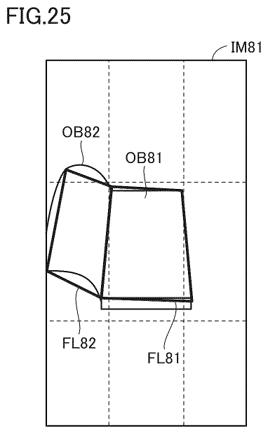

The area extraction processing is performed on captured image IM81. Thus, two objects OB81, OB82 are extracted. Object OB81 is specified as the object corresponding to the main body of the print sample because more than a given percentage thereof are located in block BK5. FIG. 25 illustrates a frame FL81 and a frame FL82 schematically illustrating a positional relationship between object OB81 and object OB82.

The vertex is detected for each of object OB81 and object OB82. For example, the vertex is detected as a portion where the angle at which two lines intersect is less than or equal to a given angle.

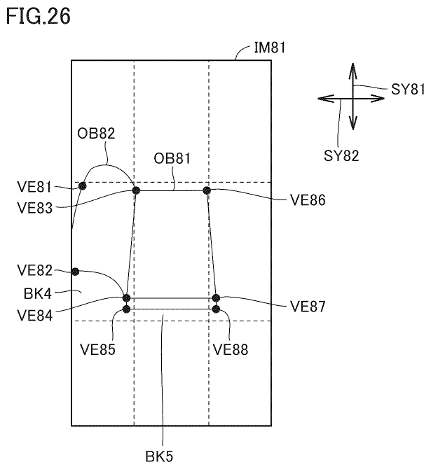

In FIG. 26, 8 vertices detected for object OB81 and object OB82 are illustrated. The detected vertices of object OB81 are six vertices VE83, VE84, VE85, VE86, VE87, VE88. The detected vertices of object OB82 are four vertices VE81, VE82, VE83, VE84. Vertices VE83, VE84, VE85 are common vertices of object OB81 and object OB82.

Among eight vertexes VE81 to VE88, the vertex located in the area corresponding to the binding position is selected. In one example, first, among eight vertexes VE81 to VE88, three vertexes located at the upper portion in the vertical direction are selected. Among the selected three vertices, the vertex located at the center in the lateral direction is specified. Then, the vertex located in a given range in the lateral direction with respect to the specified vertex is selected as the vertex located in the area corresponding to the binding position.

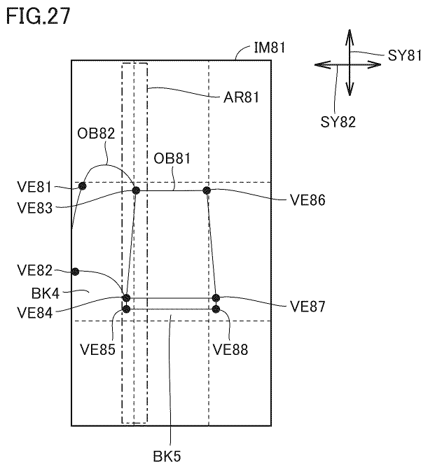

With reference to FIG. 27, selection of the vertex located in the area corresponding to the binding position will be described more specifically.

In FIG. 27, the vertical direction is indicated by a double-headed arrow SY81, and the horizontal direction is indicated by a double-headed arrow SY82. Vertexes VE81, VE83, VE86 are selected as three vertices located at the upper portion in the vertical direction. Among vertices VE81, VE83, VE86, vertex VE83 is specified as the vertex located at the center in the lateral direction. An area AR81 represents a given range in the lateral direction with respect to vertex VE83. Area AR81 includes three vertexes VE83, VE84, VE85.

Accordingly, in the example of FIG. 27, “3” is specified as the number of binding position vertices. As illustrated in FIG. 6, the feature of the number of binding position vertices “3” corresponds to the setting of the case binding “ON”. Accordingly, in the example of FIG. 27, the print setting includes the case binding “ON”. Thus, “case binding” is designated as the method for binding the medium.

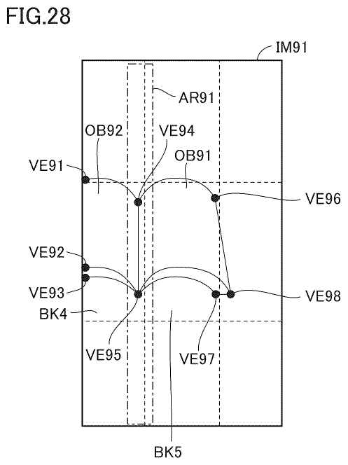

FIG. 28 illustrates another example of the captured image of the print sample.

An object OB91 and an object OB92 are extracted in a captured image IM91 of FIG. 28. Then, eight vertexes VE91 to VE98 are detected. Object OB91 is specified as the object corresponding to the main body of the print sample because more than a given percentage thereof are located in block BK5.

In FIG. 28, vertices VE91, VE94, VE96 are selected as three vertices located at the upper portion in the vertical direction. Among vertices VE91, VE94, VE96, vertex VE94 is specified as the vertex located at the center in the lateral direction. An area AR91 represents a given range in the lateral direction with respect to vertex VE94. Area AR91 includes two vertexes VE94, VE95.

Accordingly, in the example of FIG. 28, “2” is specified as the number of binding position vertices. As illustrated in FIG. 6, the feature of the number of binding position vertices “2” corresponds to the setting of the case binding “OFF”. Accordingly, in the example of FIG. 28, the print setting includes the case binding “OFF”. Captured image IM91 does not include the object corresponding to the binding member. Accordingly, in the example of FIG. 28, “saddle stitching” is designated as the method for binding the medium in the print setting.

[6. Setting of Printer Driver]

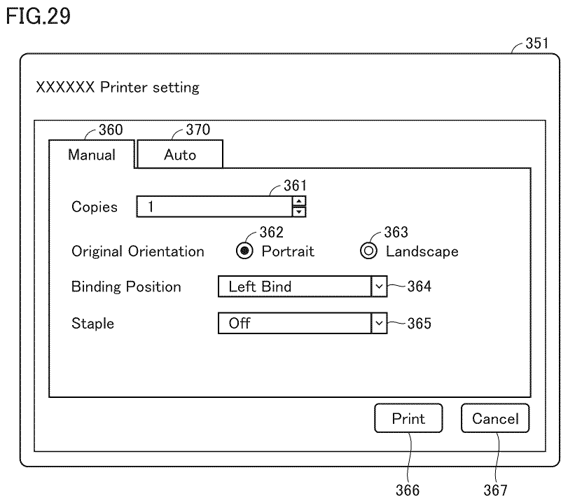

FIG. 29 is a view illustrating an example of a setting screen regarding a printer driver 320. For example, a screen 351 in FIG. 29 is displayed on display 34 of client PC 3.

Screen 351 includes a tab 360 and a tab 370. Tab 360 is a tab selecting manual setting. Tab 370 is a tab selecting automatic setting. On screen 351, the content of tab 360 is illustrated.

Tab 360 includes fields 361, 364, 365 and buttons 362, 363, 366, 367. In field 361, the number of copies is set. Button 362 and button 363 are radio buttons designating the value of the item “manuscript orientation” in the print selling. When button 362 is selected, “portrait” is set as the value of the manuscript orientation. When button 363 is selected, “landscape” is set as the value of the manuscript orientation. In field 364, the value of the item “binding position” in the print setting is set. In field 365, the value of the item “stapling” in the print setting is set.

When button 366 is operated, client PC 3 as printer driver 320 transmits a job including the print setting according to the content in tab 360 to image forming device 4. Button 367 is operated to cancel the setting of the value in tab 360.

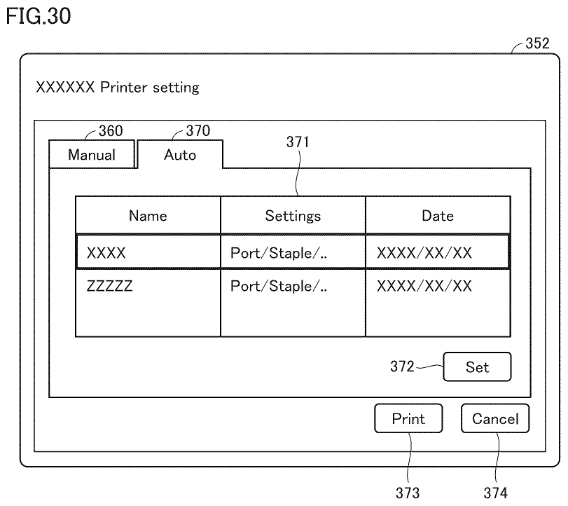

FIG. 30 is a view illustrating another example of the setting screen regarding printer driver 320. For example, a screen 352 in FIG. 30 is displayed on display 34 of client PC 3. The content of tab 370 is illustrated on screen 352.

Tab 370 includes a field 371 and buttons 372, 373, 374. Infield 371, at least one print setting acquired from print setting receiving function 310 are displayed in a list. In the example of FIG. 30, two print settings are displayed. One is the print setting with a name “XXXX” and the other is the print setting with a name “ZZZZZ”. User 10 selects one print setting from the at least one print setting displayed in the list by operating input interface 35. The selected print setting is highlighted in field 371.

When button 372 is operated, client PC 3 displays the content of the selected print setting on a separate screen, and accepts correction to the print setting. When the reception of the correction is completed, the display on the separated screen ends.

When button 373 is operated, client PC 3 as printer driver 320 transmits the job including the print setting selected in field 371 to image forming device 4. Button 374 is operated to cancel the selection of the print setting in tab 370.

[7. Processing Flow]

FIG. 31 is a flowchart illustrating processing performed as the generation of the print setting in S14 and the transmission of the print setting in S16 in FIG. 4. In one implementation, the processing in FIG. 31 is implemented by processor 21 of smartphone 2 executing a given program.

In step S1402, smartphone 2 determines whether the instruction to start the generation of the print setting is given. In one implementation example, when being activated in step S12 (FIG. 4), print setting generation function 210 of smartphone 2 requests user 10 to instruct to start the generation of the print setting. When user 10 performs the operation instructing to start the print setting, smartphone 2 determines that the start is instructed.

Smartphone 2 remains the control in step S1402 until it is determined that the start of the print setting is instructed (NO in step S1402), and when it is determined that the instruction is instructed (YES in step S1402), the control proceeds to step S1404.

In step S1404, smartphone 2 displays a first wizard on display 24.

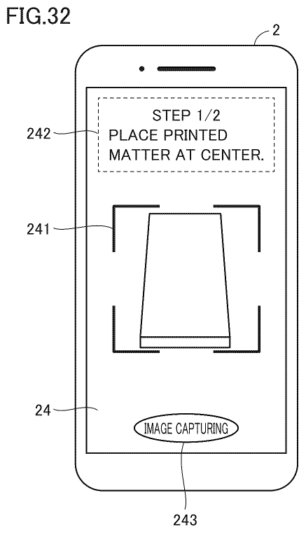

FIG. 32 is a view illustrating an example of the display screen of the first wizard. In the example of FIG. 32, smartphone 2 displays a frame 241, a message 242, and a button 243 on display 24 so as to be superimposed on the captured image of camera 26.

Frame 241 is used to align the imaging area of camera 26 with respect to the print sample. Message 242 is an example of guidance (an instruction regarding the position of the imaging area of the camera) and includes a character string “step_1/2_place printed matter at center”. With reference to message 242, user 10 aligns the imaging area of camera 26 such that mapping of the print sample falls within frame 241. Button 243 is a shutter button. The character string included in message 242 may be output as the voice.

Returning to FIG. 31, in step S1406, smartphone 2 determines whether the image capturing is instructed. In one implementation example, smartphone 2 determines that the image capturing is instructed by operating button 243 (FIG. 32). Smartphone 2 remains the control in step S1406 until it is determined that the image capturing is instructed (NO in step S1406), and when it is determined that the image capturing is instructed (YES in step S1406), the control proceeds to step S1408.

In step S1408, smartphone 2 stores the captured image of camera 26 at the timing when the image capturing is instructed in step S1406 in memory 23 as a first image.

In step S1410, smartphone 2 displays a second wizard on display 24.

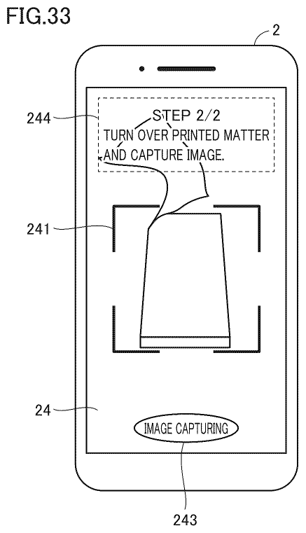

FIG. 33 is a view illustrating an example of the display screen of the second wizard. In the example of FIG. 33, smartphone 2 displays a frame 241, a message 244, and a button 243 on display 24 so as to be superimposed on the captured image of camera 26.

Message 244 is an example of guidance (an instruction to change the state of the print sample) and includes a character string “step_2/2_turn over printed matter and capture image”. With reference to message 244, user 10 opens the print sample when the print sample is a bookbound book, and turns the page of the print sample when the print sample is a booklet. The character string of message 244 may be output as the voice.

Returning to FIG. 31, in step S1412, smartphone 2 determines whether the image capturing is instructed. Smartphone 2 remains the control in step S1412 until it is determined that the image capturing is instructed (NO in step S1412), and when it is determined that the image capturing is instructed (YES in step S1412), the control proceeds to step S1414.

In step S1414, smartphone 2 stores the captured image of camera 26 at the timing when the image capturing is instructed in step S1412 in memory 23 as a second image.

In step S1416, smartphone 2 specifies the feature of the appearance of the print sample captured in the first image and the second image from the first image and the second image. For example, the feature specified in step S1416 is the feature in FIG. 6. In one implementation, the features of groups 1 to 3 in FIG. 6 are specified from the first image and the features of groups 4, 5 in FIG. 6 are specified from the second image.

In step S1418, smartphone 2 generates the print setting using the features specified in step S1416. In one implementation, in step S1416, at least one feature is specified, and in step S1418, the print setting is generated by combining respective values of settings corresponding to each of the at least one feature specified in step S1416.

In step S1420, smartphone 2 displays the print setting generated in step S1418 on display 24.

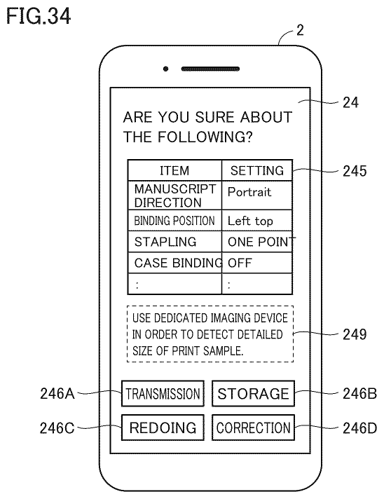

FIG. 34 is a view illustrating an example of the print setting display screen. In FIG. 34, a table 245, buttons 246A, 246B, 246C, 246D, and a message 249 are illustrated on display 24.

Table 245 represents the content of the print setting. More specifically, table 245 includes a plurality of item names (the manuscript orientation and the like) and setting values (portrait and the like) corresponding thereto.

Button 246A is operated to transmit the print setting in table 245 to client PC 3 (print setting receiving function 310). Button 246B is operated to save the print setting in table 245 in memory 23. Button 246C is operated to re-generate the print setting. Button 246D is operated to correct the print setting in table 245.

Message 249 includes a character string “use dedicated imaging device in order to detect detailed size of print sample”. User 10 referring to message 249 is prompted to use the imaging device that includes a ranging function, such as light detection and ranging (LiDAR) in order to include the detailed size of the print sample in the print setting. That is, message 249 is an example of a proposal for the use of the imaging device other than camera 26. In step S1408, when the image captured by the imaging device including the distance measuring function is acquired as the first image, smartphone 2 can include the size of the print sample specified from the image in the print setting.

Returning to FIG. 31, in steps S1422 and S1426, smartphone 2 checks the operation content of user 10 for the display in step S1420. When the operation content is “redoing” (button 246C in FIG. 34), smartphone 2 returns the control to step S1404. Thus, the first image and the second image are acquired again. In addition, smartphone 2 advances the control to step S1424 when the operation content is “correction” (button 246D in FIG. 34), advances the control to step S1428 when the operation content is “transmission” (button 246A in FIG. 34), and advances the control to step S1430 when the operation content is “save” (button 246B in FIG. 34).

In step S1424, smartphone 2 receives the input of the content correcting the print setting displayed in step S1420, and corrects the print setting according to the input content. Thereafter, smartphone 2 returns the control to step S1420. Thus, the corrected print setting is displayed on display 24.

In step S1428, smartphone 2 transmits the print setting to client PC 3 (print setting receiving function 310). The print setting to be transmitted is basically the print setting generated in step S1418. However, the print setting to be transmitted is the corrected print setting when corrected in step S1424. Thereafter, smartphone 2 ends the processing in FIG. 31. The control in step S1428 corresponds to the control in step S16 (FIG. 4).

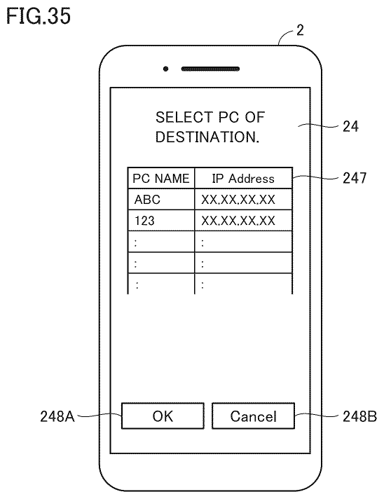

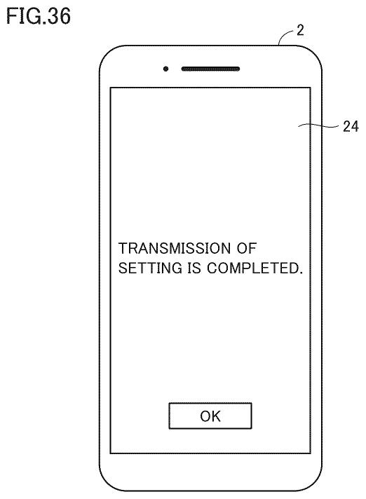

FIG. 35 is a view illustrating an example of a screen selecting a transmission destination of the print setting in smartphone 2. A table 247 and buttons 248A, 248B are displayed on display 24 in FIG. 35. Candidates for the transmission destination of the print setting are di splayed in table 247. User 10 may select the transmission destination from the candidates in table 247 by operating input interface 25 or the like. Button 248A is operated to instruct the execution of the transmission of the print setting. When button 248A is operated, smartphone 2 transmits the print setting to the selected transmission destination. FIG. 36 is a view illustrating an example of a screen notifying completion of the transmission of the print setting in smartphone 2. Button 248B is operated to cancel the transmission of the print setting. When button 248B is operated, smartphone 2 may return the control to step S1420.

In step S1430, smartphone 2 stores the print setting in memory 23. The stored print setting is basically the print setting generated in step S1418. However, the stored print setting is the corrected print setting when corrected in step S1424. Thereafter, smartphone 2 ends the processing in FIG. 31.

After the print setting is stored, print setting generation function 210 may call the print setting stored in memory 23 and receive the operation to transmit the print setting to the external device (client PC 3 or the like). Thus, user 10 can use the saved print setting later.

Print setting generation function 210 may store the print setting transmitted in step S1428 in memory 23. Thus, the print setting transmitted to one device can be transmitted to another device later.

[8. Modifications]

In the embodiment described above, smartphone 2 uses the captured image of the print sample to generate the print setting corresponding to the print sample. Camera 26 mounted on smartphone 2 was used to capture the image. The camera to be used does not need to be mounted on smartphone 2. Smartphone 2 may acquire the image captured by a camera configured separately from smartphone 2, such as a general digital camera or video camera, and generate the print setting using the captured image.

Smartphone 2 may also function as printer driver 320. In this case, smartphone 2 transmits the job to image forming device 4. That is, smartphone 2 directly transmits the generated print setting to image forming device 4.

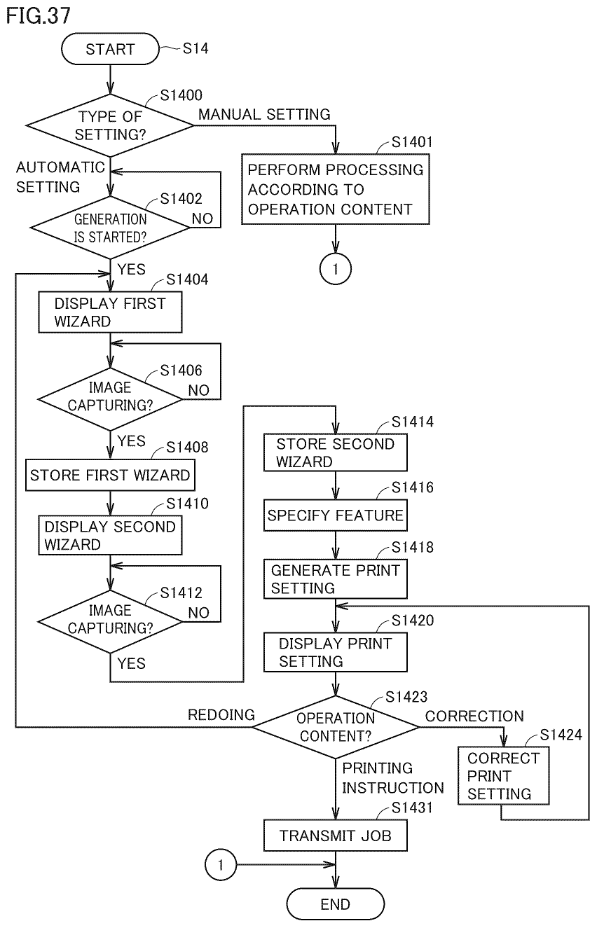

FIG. 37 is a flowchart illustrating processing of a modification in FIG. 31 when smartphone 2 also functions as the printer driver. That is, the processing in FIG. 37 is implemented by smartphone 2 functioning as print setting generation function 210 and printer driver 320. The processing in FIG. 37 is different from the processing in FIG. 31 in that the processing in FIG. 37 includes steps S1400, S1401, and S1423.

In step S1400, smartphone 2 receives the input of the selection of the type of the setting regarding the job generation. Upon receiving the input selecting “automatic setting”, smartphone 2 advances the control to step S1402, and upon receiving the input selecting “manual setting”, smartphone 2 advances the control to step S1401. When “automatic setting” is selected, as described later, the print setting generated using the captured image of the print sample is used for the job transmitted to image forming device 4. In this sense, the control in step S1400 corresponds to the reception of the selection of whether to use the print setting generated using the captured image of the print sample for the job transmitted to the image forming device.

In step S1401, smartphone 2 performs processing according to the operation content, and then ends the processing in FIG. 37. For example, the operation content is the manual input of the print setting and the print instruction.

The control in steps S1402 to S1420 in FIG. 37 may be similar to the control described with reference to FIG. 31. After displaying the print setting on display 24 in step S1420, smartphone 2 advances the control to step S1423.

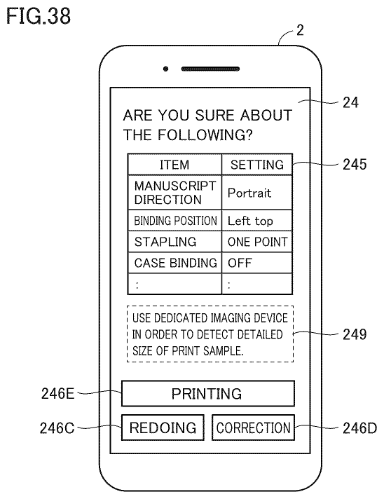

FIG. 38 is a view illustrating another example of the print setting display screen. The screen in display 24 of FIG. 38 includes a button 246E instead of buttons 246A, 246B in FIG. 34. Button 246E is operated to instruct the image forming device to perform the printing.

In step S1423, smartphone 2 checks the operation content of user 10 for the display in step S1420. When the operation content is “redoing” (button 246C in FIG. 38), smartphone 2 returns the control to step S1404. In addition, smartphone 2 advances the control to step S1424 when the operation content is “correction” (button 246D in FIG. 38), and advances the control to step S1431 when the operation content is “print instruction” (button 246E in FIG. 38).

In step S1431, smartphone 2 transmits the job including the print setting displayed in step S1420 to the image forming device. Then, the processing in FIG. 37 is ended. The print setting included in the job transmitted in step S1431 may be stored in memory 23 and reused later.

Although embodiments of the present invention have been described and illustrated in detail, the disclosed embodiments are made for purposes of illustration and example only and not limitation. The scope of the present invention should be interpreted by terms of the appended claims

What is claimed is:

1. A non-transitory recording medium that stores a computer-readable program, wherein the program causes a computer to generate print setting of an image forming device, and the program is executed by at least one processor of the computer to cause the at least one processor to execute:
acquiring at least one image of a print sample captured by a camera configured separately from the image forming device;
specifying at least one appearance feature of the print sample from the at least one image;
acquiring a value of an item corresponding to each of the at least one appearance feature by referring to information associating at least one item's value constituting the print setting with the at least one appearance feature respectively; and
generating the print setting using the value of the item.

2. The non-transitory recording medium according to claim 1, wherein the camera is a digital camera or a video camera configured separately from the computer.

3. The non-transitory recording medium according to claim 1, wherein the program further causes the at least one processor to execute providing guidance regarding acquiring the at least one image.

4. The non-transitory recording medium according to claim 3, wherein the guidance includes an instruction regarding a position of an imaging area of the camera.

5. The non-transitory recording medium according to claim 3, wherein
the acquiring the at least one image includes acquiring a first image and acquiring a second image, and
the guidance includes an instruction to change a state of a print sample after the first image is acquired and before the second image is acquired.

6. The non-transitory recording medium according to claim 5, wherein the instruction to change the state includes an instruction to open a print sample or an instruction to turn a page in the print sample.

7. The non-transitory recording medium according to claim 3, wherein the guidance includes a proposal for use of an imaging device other than the camera in order to acquire the at least one image.

8. The non-transitory recording medium according to claim 1, wherein the program causes the at least one processor to execute:
displaying the print setting; and
storing the print setting in a storage device in response to an instruction to save the print setting.

9. The non-transitory recording medium according to claim 8, wherein
the program causes the at least one processor to execute receiving correction of the print setting, and
in the storing the print setting in the storage device, the print setting after the correction is stored in the storage device.

10. The non-transitory recording medium according to claim 1, wherein the program causes the at least one processor to execute outputting the print setting to an external device in response to an instruction to output the print setting.

11. The non-transitory recording medium according to claim 10, wherein
the external device is an image forming device, and
the program causes the at least one processor to execute receiving selection of whether to use the print setting for a job output to the image forming device.

12. An information processing device comprising:
the non-transitory recording medium according to claim 1; and
at least one processor that executes a program stored in a medium.

13. The information processing device according to claim 12, further comprising a camera configured separately from the image forming device.

14. A method for generating print setting of an image forming device, the method comprising:
acquiring at least one image of a print sample captured by a camera configured separately from the image forming device;
specifying at least one appearance feature of the print sample from the at least one image;
acquiring a value of an item corresponding to each of the at least one appearance feature by referring to information associating at least one item's value constituting the print setting with the at least one appearance feature respectively; and
generating the print setting using the value of the item.
